(19) United States
(12) Patent Application Publication
(10) Pub. No.: US 2006/0221987 A1
(43) Pub. Date: Oct. 5, 2006

(54) LAN and WWAN gateway

(75) Inventor: Peter Polson, Seattle, WA (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: Junxion Inc.

(21) Appl. No.: 11/392,454

(22) Filed: Mar. 29, 2006

Related U.S. Application Data
(60) Provisional application No. 60/667,175, filed on Mar. 30, 2005.

(51) Int. Cl. H04L 12/28

(52) U.S. Cl. 370/402

(57) ABSTRACT

Methods, apparatuses, and articles of manufacture for transmitting data received from one or more devices of a local area network to a first gateway device of a first wireless wide area network, and selectively transmitting data received from the first gateway device of the first wireless wide area network to the one or more devices of the local area network, if a first wireless wide area networking interface is removably received by a socket of the gateway, the socket capable of removably receiving a selected one of the first and a second wireless wide area networking interface, and transmitting data received from the one or more devices of the local area network to a second gateway device of a second wireless wide area network, and selectively transmitting data received from the second gateway device of the second wireless wide area network to the one or more devices of the local area network, if the second wireless wide area networking interface is removably received by the socket, are described herein.

### PRIORITY CLAIM

This application claims priority to U.S. provisional patent application No. 60/667,175, filed on Mar. 30, 2005.

### FIELD OF THE INVENTION

Embodiments of the present invention relate to the field of data communication. More specifically, some embodiments of the present invention are related to bridging local area networks (LAN) and wireless wide area networks (WWAN).

### BACKGROUND

Advances in microprocessor related technology have lead to widespread development and the adoption of computing devices. Computing powers that used to be available only in expensive mainframe computers requiring special operating environments are now available in many personal-computing (PC) devices. The form factors vary from desktop, laptop, palm-sized, and so forth. A number of these computing devices are packaged as “purpose” devices, such as set-top boxes, entertainment personal digital assistants (PDA), pagers, text messengers, game devices, smart appliances and wireless mobile phones.

Concurrently, advances in networking, telecommunications and related technologies, in particular, in the area of wireless networking/communications, have led to increased connectivity between computing devices over local, private, wide area, and/or public networks. Of particular notoriety is the Internet.

Today, local area networks may be wired or wireless. Similarly, wide area networks may be wired or wireless. Examples of the former include UWB, Ethernet, serial, WiFi, and Bluetooth. Examples of the latter include cellular, PCS, or WiMAX wireless networks offered by various wireless network service providers, such as Cingular, Sprint, T-Mobile, and Clearwire.

### BRIEF DECRIPTION OF THE DRAWINGS

The present invention will be described by way of exemplary embodiments but not limitations, illustrated in the accompanying drawings in which like references denote similar elements, and in which:

FIG. 1 illustrates a system view of an example operating environment suitable for use to practice the present invention, in accordance with various embodiments;

FIG. 2 illustrates an architectural view of a device suitable for use as a LAN-WWAN Gateway, in accordance with various embodiments;

FIG. 3 illustrates the operational flow of selected aspects of a process at the Gateway for maintaining the WWAN connection;

FIG. 4 illustrates the operational flow of selected aspects of a LAN Receive process at the Gateway for handling receipt processing of LAN data;

FIG. 5 illustrates the operational flow of selected aspects of a LAN Transmit process at the Gateway for handling transmission processing of LAN data;

FIG. 6 illustrates the operational flow of selected aspects of a WWAN Receive process at the Gateway for handling receipt processing of WWAN data; and

FIG. 7 illustrates the operational flow of selected aspects of a WWAN Transmit process at the Gateway for handling transmission processing of WWAN data.

### DETAILED DESCRIPTION OF ILLUSTRATIVE EMBODIMENTS

Illustrative embodiments of the present invention include but are not limited to methods and apparatuses for transmitting data received from one or more devices of a local area network to a first gateway device of a first wireless wide area network, and selectively transmitting data received from the first gateway device of the first wireless wide area network to the one or more devices of the local area network, if a first wireless wide area networking interface is removably received by a socket of the gateway, the socket capable of removably receiving a selected one of the first and a second wireless wide area networking interface, and transmitting data received from the one or more devices of the local area network to a second gateway device of a second wireless wide area network, and selectively transmitting data received from the second gateway device of the second wireless wide area network to the one or more devices of the local area network, if the second wireless wide area networking interface is removably received by the socket.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrase “in one embodiment” is used repeatedly. The phrase generally does not refer to the same embodiment; however, it may. The terms “comprising,” “having,” and “including” are synonymous, unless the context dictates otherwise. The phrase “A/B” means “A or B”. The phrase “A and/or B” means “(A), (B), or (A and B)”. The phrase “at least one of A, B and C” means “(A), (B), (C), (A and B), (A and C), (B and C) or (A, B and C)”. The phrase “(A) B” means “(B) or (A B)”, that is, A is optional.

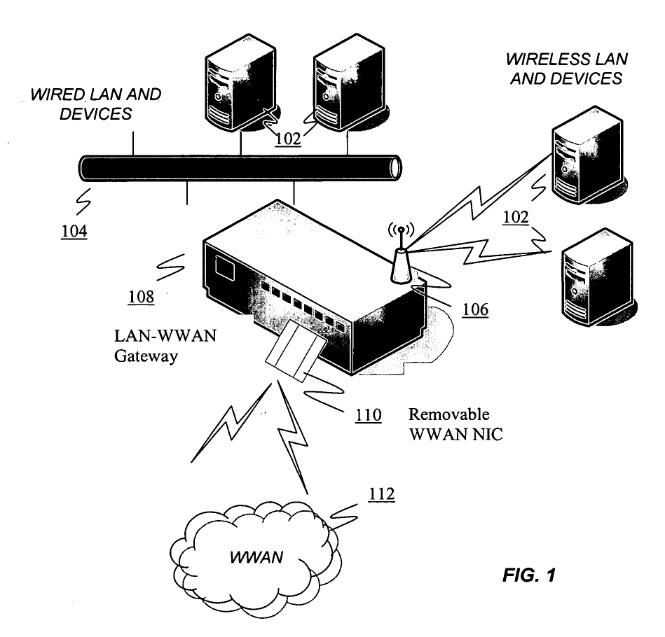

FIG. 1 illustrates a system view of an example operating environment suitable for use to practice the present invention, in accordance with various embodiments. As illustrated, gateway 108 has one or more local networking interfaces, such as wireless LAN interface 106, adapted to receive data from, and transmit data to one or more devices 102 of one or more LANs, such as the wireless LAN shown as connected to gateway 108 through local networking interface 106. Gateway 108 further comprises a socket adapted to removably receive a selected one of a first and a second WWAN networking interface, such as WWAN networking interface 110, the interface adapted to receive data from, and transmit data to a first and a second gateway device (not shown) of a first and a second WWAN, such as WWAN 112. Additionally, gateway 108 comprises a routing engine coupled to a local networking interface and the socket, and adapted to transmit data received from one or more devices 102 of a LAN 104 to a first gateway device of a first WWAN 112, and selectively transmit data received from the first gateway device of the first WWAN 112 to the one or more devices 102 of the LAN 104, if a first WWAN networking interface 110 is removably received by a socket of the gateway, and transmit data received from the one or more devices 102 of the LAN 104 to a second gateway device of a second WWAN (not shown), and selectively transmit data received from the second gateway device of the second WWAN to the one or more devices 102 of the LAN 104, if the second WWAN networking interface is removably received by the socket.

In various embodiments, the one or more devices 102 of one or more LANs may be any sort of computing device known in the art, such as PCs, workstations, servers, PDAs, pagers, text messengers, game devices, smart appliances, and wireless mobile phones. The devices may connect to the LAN using any sort of connection known in the art, such as a TCP/IP connection, or an ATM virtual connection. Devices 102 may further receive data from a LAN 104 and may transmit data to the LAN 104. Data to be transmitted and/or received may include both content and requests for content, and may consist of any sequence of zero, one, or more bits.

As shown, gateway 108 may be connected to either a wired and/or a wireless LAN. A LAN connected to gateway 108 may use common standards for data transmission, such as Ethernet, Bluetooth, and 802.11, although the LAN may use any standard for data transmission known in the art. LAN 104 may further comprise a LAN router (not shown) capable of routing LAN traffic between devices 102 of the LAN 104, and of routing traffic from any one or more devices 102 of the LAN 104 that is directed to a WWAN to gateway 108. In alternate embodiments, gateway 108 may additionally act as the LAN router, receiving traffic from one device 102 of LAN 104 and directing traffic back to another device 102 of the same LAN 104. The one or more devices 102 of LAN 104 may all be located in the same building or room, as in the case of a wired LAN, or in the same geographic area, as in the case of a wireless LAN. Because of the geographic proximity and limited number of hops for a given transmission, data may be transferred across a LAN at a high rate of speed.

In some embodiments, local networking interfaces may be of any sort known in the art, including Ethernet interfaces, Bluetooth interfaces, and 802.11 wireless interfaces, such as wireless local networking interface 106. The local networking interface may thus consist of a PC card to be received by a PC card port of gateway 108, a miniPCI wireless interface, an interface embedded into the PCB, or a radio antenna, the PC Card, miniPCI, embedded interface, and/or antenna facilitating 802.11 wireless transmission. The local networking interface may also consist of an Ethernet port of gateway 108 receiving an Ethernet cable, the cable further connected to, in some embodiments, a LAN router.

As is further shown, gateway 108 may have multiple local networking interfaces, such as an interface connected to wired LAN 104 and a wireless local networking interface 106 connected to a wireless LAN. In alternate embodiments, gateway 108 may comprise multiple wired LAN interfaces, multiple wireless LAN interfaces, or some combination of one or more of both. Additionally, the routing engine of gateway 108 described above may be further adapted to transmit data received from a device 102 of one LAN 104 to another device 102 of a second LAN.

Additionally, in various embodiments, gateway 108 may further comprise a configuration/management process (not shown) to provide a LAN IP address to all devices 102 of a LAN 104 that may not change if the WWAN 112 is temporarily disconnected. Thus, transmission of LAN-to-LAN traffic is facilitated even in the absence of a WWAN connection.

Further, as is used herein, the term “gateway” refers to any computing device facilitating transmission of data from one or more LANs to a WWAN, and transmission of data from the WWAN to one or more of the one or more LANs. The interfaces, sockets, routing engine, other processes, and storage comprising the gateway 108 may, in some embodiments comprise a single enclosure. Additionally, gateway 108 may be provided with LED lights and display screens on the gateway 108 or on an attached peripheral device to indicate the status of the gateway 108 as well as the status of the LAN and/or WWAN connections.

In some embodiments, gateway 108 may be adapted to be powered through a wall outlet, a vehicle power adapter, or an internal or external battery. Inclusion of the latter power supplies enables the gateway 108 to be used in portable settings. For example, teams of users may carry the gateway 108 in a briefcase or bag. Gateway 108 may also be mounted in a building, vehicle, server rack, or other fixed location.

Also, gateway 108 may adjust the power available to the LAN or WWAN network interfaces 106/110 to improve performance. For example, more power to either the LAN or WWAN network interfaces 106/110 may improve the speed, persistence, and reliability of the interface. Less power to either interface may reduce the power requirements of the gateway 108 and, when used with a battery, extend the operating time before the battery power is drained.

The routing engine of gateway 108 may, in some embodiments, facilitate two-way transmission of data to and from the one or more LANs and to and from one or more WWANs. Transmission of data from one device 102 of a LAN 104 to another device 102 of a second LAN is described in greater detail above.

When receiving data from a device 102 of a LAN 104 destined for a WWAN 112, the routing engine of gateway 108 may, in some embodiments, determine if the data received from the device 102 is a request for content from the WWAN 112, and may further determine if such content is cached in storage of gateway 108. If the content is cached, the routing engine may simply retrieve the requested content from the storage of gateway 108, and transmit the content to the device 102 of LAN 104 requesting the content. In such embodiments, no current connection to WWAN 112 is required.

If on the other hand the content is not cached, or the data received from device 102 of LAN 104 is not a request for content, the routing engine may, in various embodiments, compress the received data prior to transmitting it. By compressing the data, the routing engine may facilitate transmission of the data at a higher speed than might otherwise be achieved, especially given the typically low speeds at which data is transmitted across a WWAN. Such compression may be achieved through recourse to any compression algorithm known in the art, such as Huffman, Lempel-Ziv, or Venturi, or any combination of such algorithms.

In some embodiments, after compressing the received data, the routing engine of gateway 108 may determine whether the gateway 108 is connected to any gateway of any WWAN 112 before attempting transmission of data to the WWAN 112. The routing engine may determine whether a connection exists by pinging an address of a WWAN 112 and listening for a reply. If no reply is received, the routing engine may wait some pre-determined time and try again. After a certain number of attempts have been met without success, the routing engine may, in some embodiments, buffer the data to be transmitted in some sort of data structure and continue on an intermittent basis to attempt connection to the WWAN 112. Once a connection has been achieved, the buffered data may then be transmitted to its appropriate destination.

In other embodiments, gateway 108 may also include a networking interface to receive a wired WAN connection. Such a connection may be achieved via an Ethernet plug and cable received into an Ethernet port of the gateway 108. In such embodiments, the wired WAN connection may serve as a backup that the gateway 108 may switch to if the WWAN 112 connection is unavailable. Gateway 108 may then attempt connection with the wired WAN, in some embodiments by pinging the wired WAN. If the wired WAN is also unavailable, gateway 108 may buffer the data in the manner described above.

Still in other embodiments, a configuration/management process of gateway 108 such as the one described above may communicate the status of the WWAN 112 to the one or more devices 102 of the one or more LANs 104 through a web page. Such status information may include availability of (connection to) WWAN 112, WWAN 112 signal strength, the WWAN 112 IP address, and statistics about the users and data being transmitted through the WWAN112.

In various embodiments, a configuration/management process of gateway 108 may be adapted to shut down or otherwise restrict transmission to the LAN 104 or a second LAN when no WWAN 112 access is available.

Additionally, in some embodiments, gateway 108 may be adapted to prioritize specific data over the WWAN 112 to manage conflicts between devices 102 of LANs 104 that are sharing limited WWAN 112 capacity.

Once a connection to WWAN 112 has been determined to exist, however, the routing engine of gateway 108 may transmit the received data to its destination via the connected WWAN 112.

In still other embodiments, the routing engine of gateway 108 is adapted to transmit data received from a WWAN 112 to one or more devices 102 of one or more LANs 104. Upon receiving the data from WWAN 112, the routing engine may first, in various embodiments, decompress the data, if the data is compressed. As mentioned above, compression of data may result in higher transmission speeds across a WWAN 112. The routing engine may employ any compression algorithm known in the art to achieve decompression of the data, such algorithms including Huffman, Lempel-Ziv, Venturi, or any combination of such algorithms.

Upon decompressing the data, the routing engine may, in some embodiments, next determine if the data is content received from a device of a WWAN 112. If the data is determined to comprise some sort of content, such as a web page, a PDF, or any other sort of content known in the art, the routing engine may then determine if the content is cached in storage of gateway 108. If the received content is not cached, the routing engine, in various embodiments, may cache the content received from the WWAN 112 in a data structure of some type known in the art, and store the cached content in storage of gateway 108.

In some embodiments, the routing engine of gateway 108 may then transmit the received data to its destination device 102 via the LAN 104 to which destination device 102 is connected.

As is further shown, gateway 108 comprises a socket adapted to receive a WWAN networking interface 110. The WWAN networking interface 110 may be of any sort known in the art, such as cellular, PCS, and WiMax WWAN networking interfaces. The interface may come in the form of a PC Card or Modem, the PC Card or Modem capable of plugging into the socket of gateway 108.

In various embodiments, each WWAN networking interface may be adapted for a specific wireless service provider. Thus, gateway 108 facilitates the switching of WWAN networking interfaces in areas where another provider having a different WWAN networking interface is stronger, or where the provider associated with the current WWAN networking interface 110 does not provide service. Accordingly, the use of multiple WWAN networking interfaces 110 with the socket of gateway 108 facilitates the mobility of the gateway 108, as described above.

In still other embodiments not illustrated, gateway 108 may support multiple WWAN networking interfaces removably received by multiple sockets of gateway 108. By employing multiple sockets and multiple WWAN networking interfaces 110, gateway 108 may facilitate connection to multiple WWAN service providers. If WWAN 112 is not available because of the location of the user or issues with the service provider of the WWAN 112, WWAN access may be provided via the other WWAN connection. However, one or more of the WWAN networking interfaces may be built in. Additionally, the gateway 108 may be adapted to support multiple WWAN networking interfaces 110 connecting simultaneously to the same WWAN 112. The combination of networking interfaces may increase the performance, speed, and reliability of the WWAN 112 connection.

As is shown, WWAN 112 may comprise any sort of WWAN known in the art, such as a cellular, a PCS, or a WiMax WWAN. WWAN 112 may consist of a network of routers and gateways, of which gateway 108 is a part, working together to transmit data to various devices connected directly or indirectly to a router or gateway of WWAN 112, such as the devices 102 connected to gateway 108 via LAN 104. The routers and gateways of WWAN 112 may utilize any sort of connection type known in the art, such as TCP/IP connections or ATM virtual connections. Additionally, WWAN 112 may provide access to the Internet through another gateway or set of gateways.

In further embodiments, the gateway 108 may provide radio antenna enhancements for the WWAN 112 through either a passive or an active antennas apparatus in gateway 108. This antenna apparatus may be directional or omni-directional. The radio antenna enhancements may improve the reliability, throughput, and performance of the WWAN 112. The enhancements may also provide improved performance for other nearby, unrelated devices using a WWAN, such phones or modems using cellular, PCS, WiMAX, or other WWAN networks.

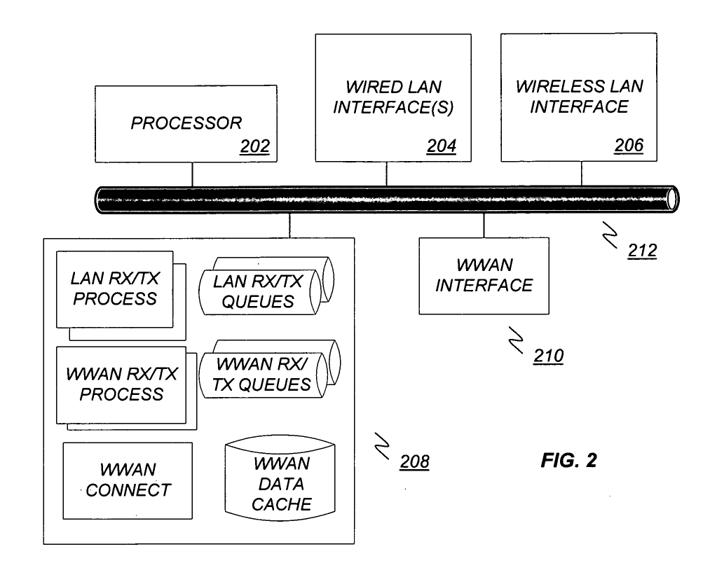

FIG. 2 illustrates an architectural view of a device suitable for use as a LAN-WWAN Gateway, in accordance with various embodiments. As shown, gateway 108 may include one or more processors, such as processor 202 and persistent storage 208. Additionally, gateway 108 includes a plurality of networking interfaces, such as wired LAN interface 204, wireless LAN interface 206, and WWAN interface 210, and wired WAN interface (not shown). The LAN interfaces 204 and 206 may include 802.11, Bluetooth, and Ethernet local networking interfaces, as is described in greater detail above. Also, the WWAN interface 210 may be a cellular, a PCS, or a WiMax WWAN networking interface in the form of a removable PC Card, embedded modem, or other modem to connect to a WWAN 112, the WWAN networking interface also described in greater detail above.

In various embodiments, a card slot (not shown) may be used to allow users of gateway 108 to install or upgrade either the LAN or WWAN interfaces with updated LAN or WWAN interfaces. When new network interfaces and services are available, users can update the gateway 108 to support these interfaces and services by inserting a new interface into the LAN or WWAN card slot.

Further, the elements are coupled to each other via system bus 212, which represents one or more buses. In the case of multiple buses, the buses are bridged by one or more bus bridges (not shown). Each of these elements performs its conventional functions known in the art. In particular, persistent storage 208 is employed to store programming modules adapted to receive and transmit data to and from a LAN (shown as “LAN RX/TX Process”), to receive and transmit data to and from a WWAN (shown as “WWAN RX/TX Process”) and to monitor the WWAN connection. Additionally, persistent storage 208 is also employed to store a WWAN data cache of cached WWAN content, and as well as data queues/buffers for data received from LAN 104, data to be transmitted to LAN 104, data received from WWAN 112, and data to be transmitted to WWAN 112. The instructions implementing the programming modules, the WWAN data cache, and the queues/buffers may be loaded into persistent storage 208 in the factory, or in the field, through a distribution medium (not shown) or through LAN and/or WWAN interfaces 204, 206, and/or 210.

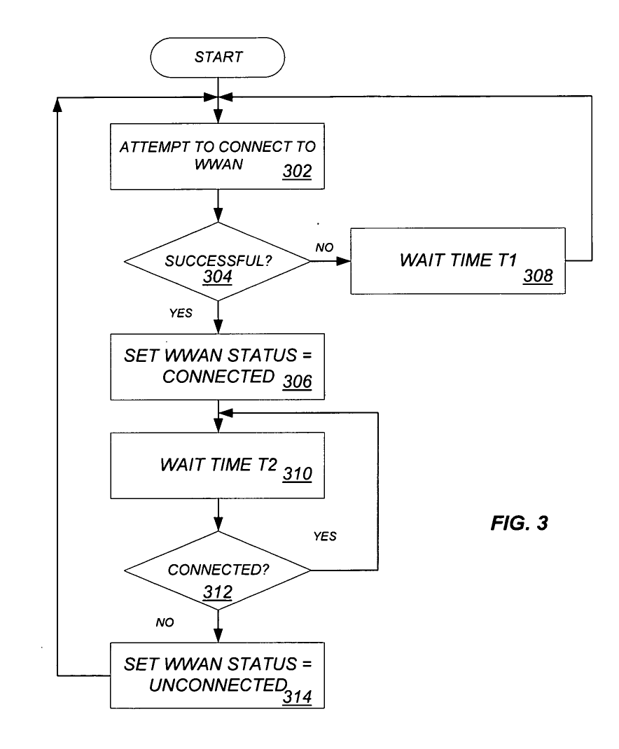

FIG. 3 illustrates the operational flow of selected aspects of a process at the gateway 108 for maintaining the WWAN 112 connection.

In some embodiments, the routing engine of gateway 108 may determine whether the gateway 108 is connected to any gateway of any WWAN 112 before attempting transmission of data to the WWAN 112. As is shown, the routing engine may attempt to connect to a WWAN 112, block 302, by pinging an address of a WWAN 112 and listening for a reply. If no reply is received, block 304, the routing engine may wait some pre-determined time, here shown as time T1, block 308, and try again, block 302. After a certain number of attempts have been met without success, the routing engine may, in some embodiments, buffer the data to be transmitted in some sort of data structure and continue on an intermittent basis to attempt connection to the WWAN 112 (not shown). Once a connection has been achieved, the buffer data may then be transmitted to its appropriate destination.

If on the other hand an attempt to connect to WWAN 112 was successful, block 304, the routing engine may, in some embodiments, set a gateway 108 WWAN connection status variable to “connected,” block 306, or where the variable is Boolean, to “true.” At some pre-determined time interval, here shown as time T2, block 310, the routing engine may again attempt to connect to WWAN 112 to ensure that the connection still exists, block 312. This may again be accomplished by pinging an address of WWAN 112. If the connection is determined to exist, block 312, the routing engine may again wait a predetermined time T2, block 310, and attempt to connect to WWAN 112 again. On the other hand, if the routing engine determines that a WWAN 112 connection no longer exists, block 312, the routing engine may, in some embodiments, set a gateway 108 WWAN connection status variable to “unconnected,” block 314, or where the variable is Boolean, to “false.” The WWAN connect process illustrated by FIG. 3 may then again loop back and attempt to reestablish a connection to WWAN 112, block 302.

In various embodiments, not illustrated herein, facilities may be provided to enable a user of gateway 108 to configure the address of the ping and the interval between pings, such as time intervals T1 and T2.

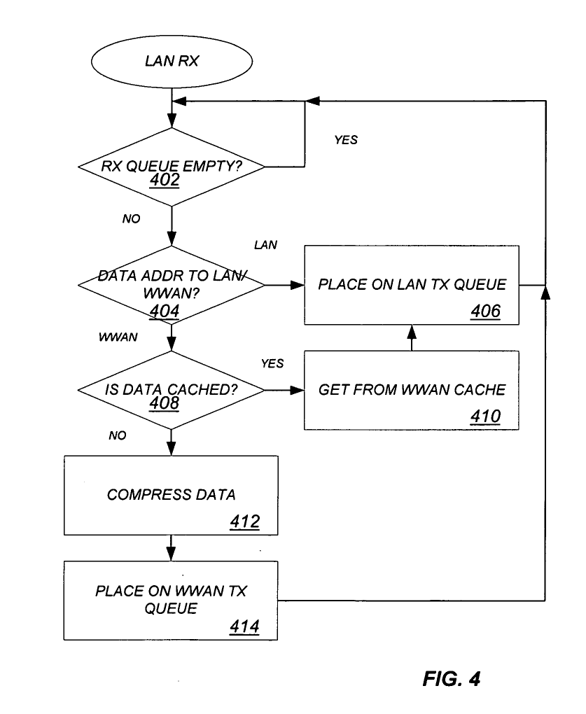

FIG. 4 illustrates the operational flow of selected aspects of a LAN Receive process at the gateway 108 for handling receipt processing of LAN data. As is illustrated, the routing engine implementing the LAN Receive process may first determine if a LAN Receive Queue of gateway 108 is empty, block 402. The queue may be implemented as any sort of data structure known in the art capable of organizing and storing data. Data received from a LAN may, in some embodiments, first be placed in this receive queue. If empty, the routing engine may check the queue periodically, on some basis, until it is not found to be empty. In other embodiments, received LAN data is processed as it is received, and is not placed in a receive queue. In yet other embodiments, the receive queue may contain buffered LAN data that has been placed in the queue to await transmission while a connection to a WWAN 112 is unavailable.

Upon determining that the receive queue is not empty, the routing engine implementing the LAN Receive process may next determine whether the received LAN data is destined for another device 102 of the same LAN 104 or of a second LAN, or whether the received data is destined for a device accessible over a WWAN 112, block 404. If destined for a device 102 of a LAN 104 or a second LAN, the data may be placed in a LAN Transmit Queue of gateway 108, block 406. The queue may be implemented as any sort of data structure known in the art capable of organizing and storing data. In other embodiments, the data may be transmitted immediately to the destination device 102 without being placed in such a queue.

As is shown, if on the other hand, the data is destined for a device accessible over a WWAN 112, the LAN Receive process of the routing engine may then determine whether the data is cached, block 408. Such a determination may be appropriate where the data received from a device 102 of a LAN 104 is a request for content from a device of a WWAN 112, and the content may be cached in the persistent storage 208 of gateway 108. If the content is cached, the routing engine may simply retrieve the requested content from the storage of gateway 108, block 410, and transmit the content to the device 102 of LAN 104 requesting the content. In alternate embodiments, rather than immediately transmitting the cached content, the LAN Receive process of the routing engine may place the cached content on a LAN Transmit Queue of gateway 108, block 406, such as the one described above. In such embodiments, no current connection to the WWAN 112 is required.

If on the other hand the content is not cached, or the data received from device 102 of LAN 104 is not a request for content, the LAN Receive process implemented by the routing engine may, in various embodiments, compress the received data prior to transmitting it, block 412. By compressing the data, the routing engine may facilitate transmission of the data at a higher speed than might otherwise be achieved, especially given the typically low speeds at which data is transmitted across a WWAN. Such compression may be achieved through recourse to any compression algorithm known in the art, such as Huffman, Lempel-Ziv, or Venturi, or any combination of such algorithms.

After compressing the data, the LAN Receive Process may, in some embodiments, place the data in a WWAN Transmission Queue of gateway 108, block 414, to await transmission across WWAN 112. In alternate embodiments, the routing engine may, immediately following compressing, determine if a WWAN 112 connection exists, as is further illustrated and described above, and if such a connection exists, transmit the data across the WWAN 112 to its destination.

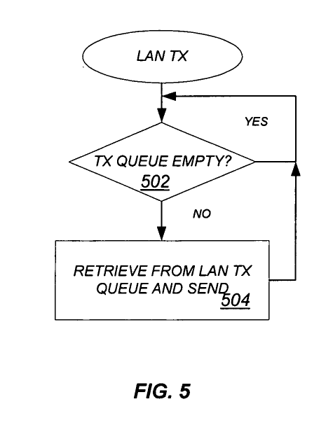

FIG. 5 illustrates the operational flow of selected aspects of a LAN Transmit process at the gateway 108 for handling transmission processing of LAN data. As is illustrated, the routing engine implementing the LAN Transmit process may first determine if a LAN Transmit Queue of gateway 108 is empty, block 502. The queue may be implemented as any sort of data structure known in the art capable of organizing and storing data. Data to be transmitted to a device 102 of a LAN 104 may, in some embodiments, first be placed in this transmit queue. If empty, the routing engine may check the queue periodically, on some basis, until it is not found to be empty. In other embodiments, data to be transmitted to a device 102 of the LAN 104 is transmitted immediately after processing, and is not placed in a transmit queue.

As is shown, the LAN Transmit process implemented by the routing engine may next retrieve the data from the LAN Transmit queue and send the data to its destination device 102 via the LAN 104 connected to the gateway 108 via a local networking interface 106, block 504.

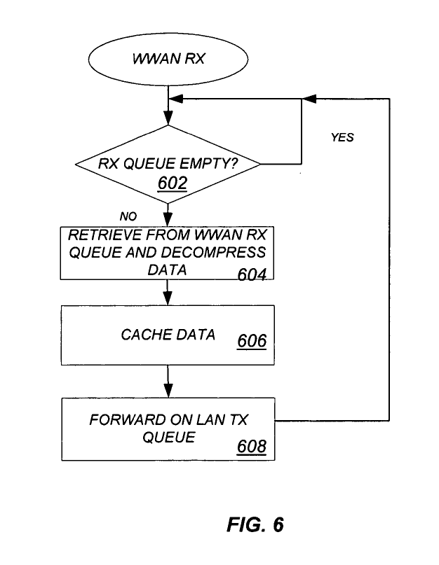

FIG. 6 illustrates the operational flow of selected aspects of a WWAN Receive process at the gateway 108 for handling receipt processing of WWAN data. As is illustrated, the routing engine implementing the WWAN Receive process may first determine if a WWAN Receive Queue of gateway 108 is empty, block 602. The queue may be implemented as any sort of data structure known in the art capable of organizing and storing data. Data received from a WWAN may, in some embodiments, first be placed in this receive queue. If empty, the routing engine may check the queue periodically, on some basis, until it is not found to be empty. In other embodiments, received WWAN data is processed as it is received, and is not placed in a receive queue.

In various embodiments, the WWAN Receive process implemented by the routing engine may next retrieve data from the WWAN receive queue and decompress the received data, block 604, if the data is compressed. As mentioned above, compression of data may result in higher transmission speeds across a WWAN 112. The routing engine may employ any compression algorithm known in the art to achieve decompression of the data, such algorithms including Huffman, Lempel-Ziv, Venturi, or any combination of such algorithms.

Upon decompressing the data, the WWAN Receive process of the routing engine may, in some embodiments, next determine if the data is content received from a device of a WWAN 112. If the data is determined to comprise some sort of content, such as a web page, a PDF, or any other sort of content known in the art, the routing engine may then determine if the content is cached in persistent storage 208 of gateway 108. If the received content is not cached, the routing engine, in various embodiments, may cache the content received from the WWAN 112, block 606, in a data structure of some type known in the art, and store the cached content in the persistent storage 208 of gateway 108. Other caching may be proactive, storing new data at non-peak hours when the WWAN 112 is underutilized.

After caching the data, the WWAN Receive Process may, in some embodiments, place the data in a LAN Transmit Queue of gateway 108, block 608, to await transmission to its destination device 102 of LAN 104. In alternate embodiments, the routing engine may, immediately following caching, transmit the data across the LAN 104 to its destination device 102.

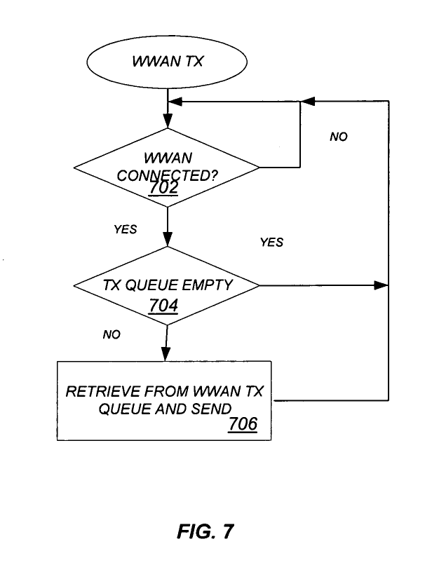

FIG. 7 illustrates the operational flow of selected aspects of a WWAN Transmit process at the gateway 108 for handling transmission processing of WWAN data. As is illustrated, the routing engine implementing the WWAN Transmit process may first determine if a WWAN 112 connection exists, block 702. The operations for determining whether such a connection exists are illustrated by FIG. 3 and described in greater detail above.

As is shown, the routing engine implementing the WWAN Transmit process may then determine if a WWAN Transmit Queue of gateway 108 is empty, block 704. The queue may be implemented as any sort of data structure known in the art capable of organizing and storing data. Data to be transmitted to a device connected to a WWAN 112 may, in some embodiments, first be placed in this transmit queue. If empty, the routing engine may check the queue periodically, on some basis, until it is not found to be empty. In other embodiments, data to be transmitted to a device of the WWAN 112 is transmitted immediately after processing, and is not placed in a transmit queue.

As is shown, the WWAN Transmit process implemented by the routing engine may next retrieve the data from the WWAN Transmit queue and send the data to its destination device via the WWAN 112 connected to the gateway 108 via a WWAN networking interface 110.

Although specific embodiments have been illustrated and described herein, it will be appreciated by those of ordinary skill in the art that a wide variety of alternate and/or equivalent implementations may be substituted for the specific embodiments shown and described, without departing from the scope of the present invention. This application is intended to cover any adaptations or variations of the embodiments discussed herein. Therefore, it is manifestly intended that this invention be limited only by the claims and the equivalents thereof.

What is claimed:

1. A gateway comprising:
a local networking interface adapted to receive data from, and transmit data to one or more devices of a local area network;
a socket adapted to removably receive a selected one of a first and a second wireless wide area networking interface adapted to receive data from, and transmit data to a first and a second gateway device of a first and a second wireless wide area network respectively; and
a routing engine coupled to the local networking interface and the socket, and adapted to transmit data received from the one or more devices of the local area network to the first gateway device of the first wireless wide area network, and selectively transmit data received from the first gateway device of the first wireless wide area network to the one or more devices of the local area network, if the first wireless wide area networking interface is the selected one removably received by the socket, and to transmit data received from the one or more devices of the local area network to the second gateway device of the second wireless wide area network, and selectively transmit data received from the second gateway device of the second wireless wide area network to the one or more devices of the local area network, if the second wireless wide area networking interface is the selected one removably received by the socket.

2. The gateway of claim 1, wherein the gateway further includes a processor adapted to operate the routing engine.

3. The gateway of claim 2, wherein the routing engine is operated by the processor and the gateway further includes a storage medium storing a plurality of programming instructions implementing the routing engine.

4. The gateway of claim 1, further comprising a second local networking interface adapted to receive data from, and transmit data to one or more devices of another local area network.

5. The gateway of claim 4, wherein the routing engine is further adapted to transmit data received from a device of one of the local area networks to another device of the same or the other the local area network.

6. The gateway of claim 1, wherein the routing engine is further adapted to compress the data to be transmitted to the first gateway device of the first wireless wide area network or the second gateway device of the second wireless wide area network, and/or to decompress the data received from the first gateway device of the first wireless wide area network or the second gateway device of the second wireless wide area network.

7. The gateway of claim 1, wherein the routing engine is further adapted to cache the data received from the first gateway device of the first wireless wide area network or the second gateway device of the second wireless wide area network.

8. The gateway of claim 1, wherein the routing engine is further adapted to determine whether the gateway is connected to one of the first and the second wireless wide area networks before transmitting data to the connected one of the first gateway device of the first wireless wide area network and the second gateway device of the second wireless wide area network.

9. The gateway of claim 8, wherein the routing engine is further adapted to buffer data to be transmitted to a gateway device of a wireless wide area network when the gateway does not have a connection to any gateway device of any wireless wide area network.

10. The gateway of claim 1, wherein the local networking interface is either an 802.11, a Bluetooth, or an Ethernet local networking interface.

11. The gateway of claim 1, wherein at least one of the first and second wireless wide area networking interfaces is either a cellular, a PCS, or a WiMax wireless wide area networking interface.

12. The gateway of claim 11, wherein each of the first and the second wireless wide area networking interfaces is adapted for a different wireless service provider.

13. In a gateway, a method comprising:
receiving data from one or more devices of a local area network;
transmitting the received data to a first gateway device of a first wireless wide area network, if a first wireless wide area networking interface is removably received by a socket of the gateway, the socket adapted to receive one of the first and a second wireless wide area network interface; and
transmitting the received data to a second gateway device of a second wireless wide area network, if the second wireless wide area networking interface is removably received by the socket of the gateway.

14. The method of claim 13, further comprising:
determining if the received data is destined for one or more devices of the local area network or for second one or more devices of a second local area network; and
transmitting the received data to the one or more devices of the local area network or the second one or more devices of the second local area network, if it is determined that the data is destined for the one or more devices or the second one or more devices, respectively.

15. The method of claim 13, further comprising compressing the received data to be transmitted to the first gateway device of the first wireless wide area network or the second gateway device of the second wireless wide area network.

16. The method of claim 13, wherein the received data comprises a request for content, and the method further comprises:
determining whether the requested content is cached on the gateway; and
if the requested content is cached on the gateway, transmitting the cached content to at least one of the one or more devices of the local area network having made the request.

17. The method of claim 13, further comprising determining whether the gateway is connected to any gateway device of any wireless wide area network.

18. The method of claim 17, further comprising buffering the received data if the gateway does not have a connection to any gateway device of any wireless wide area network connection.

19. In a gateway, a method comprising:
receiving data from a first gateway device of a first wireless wide area network, if a first wireless wide area networking interface is removably received by a socket of the gateway, the socket adapted to receive one of the first and a second wireless wide area network interface;
receiving data from a second gateway device of a second wireless wide area network, if the second wireless wide area networking interface is removably received by the socket of the gateway; and
selectively transmitting the received data to one or more devices of a local area network.

20. The method of claim 19, further comprising decompressing the data received from the first gateway device of the first wireless wide area network and/or the second gateway device of the second wireless wide area network.

21. The method of claim 19, further comprising selectively caching the data received from the first gateway device of the first wireless wide area network and/or the second gateway device of the second wireless wide area network.

22. An article of manufacture comprising:
a storage medium having a plurality of programming instructions stored therein, the plurality of programming instructions adapted to program a gateway to enable the gateway to
transmit data received from one or more devices of a local area network to a first gateway device of a first wireless wide area network, and selectively transmit data received from the first gateway device of the first wireless wide area network to the one or more devices of the local area network, if a first wireless wide area networking interface is removably received by a socket of the gateway, the socket capable of removably receiving a selected one of the first and a second wireless wide area networking interface, and
transmit data received from the one or more devices of the local area network to a second gateway device of a second wireless wide area network, and selectively transmit data received from the second gateway device of the second wireless wide area network to the one or more devices of the local area network, if the second wireless wide area networking interface is removably received by the socket.

23. The article of claim 22, wherein the plurality of programming instructions are further adapted to receive data from, and transmit data to one or more devices of an other local area network.

24. The article of claim 23, wherein the plurality of programming instructions are further adapted to transmit data received from a device of one of the local area networks to another device of the other local area network.

25. The article of claim 22, wherein the plurality of programming instructions are further adapted to compress the data to be transmitted to the first gateway device of the first wireless wide area network or the second gateway device of the second wireless wide area network, and/or to decompress the data received from the first gateway device of the first wireless wide area network or the second gateway device of the second wireless wide area network.

26. The article of claim 22, wherein the plurality of programming instructions are further adapted to cache the data received from a gateway device of a wireless wide area network.

27. The article of claim 22, wherein the plurality of programming instructions are further adapted to determine whether the gateway has a connection to a gateway device of a wireless wide area network.

28. The article of claim 27, wherein the plurality of programming instructions are further adapted to buffer data to be transmitted when the gateway device does not have a connection to any gateway device of any wireless wide area network.

29. The article of claim 22, wherein the plurality of programming instructions are further adapted to receive and/or transmit data to one or more devices of a local area network using a local networking interface of the gateway, and the local networking interface is either an 802.11, a Bluetooth, or an Ethernet local networking interface.

30. The article of claim 22, wherein the plurality of programming instructions are further adapted to receive and/or transmit data to a gateway device of a wireless wide area network using a wireless wide area networking interface of the gateway, and the wireless wide area networking interface is either a cellular, a PCS, or a WiMax wireless wide area networking interface.

31. A gateway comprising:
a local networking interface adapted to receive data from, and transmit data to one or more devices of a local area network;
a wireless wide area networking interface adapted to receive data from, and transmit data to a gateway device of a wireless wide area network; and
a routing engine coupled to the local networking interface and the wireless wide area networking interface, and adapted to transmit data received from the one or more devices of the local area network to the gateway device of the wireless wide area network, and selectively transmit data received from the gateway device of the wireless wide area network to the one or more devices of the local area network.

32. The gateway of claim 31, wherein the routing engine is further adapted to compress the data to be transmitted to the gateway device of the wireless wide area network, and/or to decompress the data received from the gateway device of the wireless wide area network.

33. The gateway of claim 31, wherein the routing engine is further adapted to cache the data received from the gateway device of the wireless wide area network.

34. The gateway of claim 31, wherein the routing engine is further adapted to determine whether the gateway is connected to the wireless wide area network before transmitting data to the gateway device of the wireless wide area network.

35. The gateway of claim 34, wherein the routing engine is further adapted to buffer data to be transmitted to a gateway device of a wireless wide area network when the gateway does not have a connection to any gateway device of any wireless wide area network.
